(19) United States
(12) Patent Application Publication
(10) Pub. No.: US 2021/0245192 A1
(43) Pub. Date: Aug. 12, 2021

(54) COATING NOZZLE AND COATING DEVICE

(71) Applicant: HONDA MOTOR CO., LTD., Tokyo (JP)

(72) Inventors: Koji ODA, Tochigi (JP); Hidekazu RYU, Tochigi (JP)

(21) Appl. No.: 17/054,173

(22) PCT Filed: May 9, 2019
(86) PCT No.: PCT/JP2019/018545

§ 371 Date: Nov. 10, 2020

(30) Foreign Application Priority Data
May 10, 2018 (JP) 2018-091057

(51) Int. Cl. B05C 5/02

(52) U.S. Cl. CPC B05C 5/0225

(57) ABSTRACT

A coating nozzle 5 is provided with a holder part 6 attachable to the distal-end part of a gun base 4, and a nozzle body 7 which is housed in the holder part 6 and which has a discharge opening 73, and a valve seat part 72 in which a needle valve 42 for opening and closing the discharge opening 73 is seated. The nozzle body 7 is provided with a nozzle body distal-end part 77 in which the discharge opening 73 is formed and which protrudes past a first holder tapered surface 67 of the holder part 6. The nozzle body 7 is supported by the holder part 6 so as to slide with respect to the holder part 6 when a load is applied to the nozzle body distal-end part 77 from a discharge opening 73 side to a valve seat part 72 side.

### TECHNICAL FIELD

The present invention relates to a coating device that coats a workpiece with a fluid material such as an adhesive, a sealant or a filler, and a coating nozzle for use in this coating device.

### BACKGROUND ART

In Patent Document 1, disclosed is a coating gun attached to a distal-end part of a robot arm of an industrial robot. This coating gun comprises a gun body including a flow path through which a fluid material such as an adhesive flows, a coating nozzle connected to a downstream end of the flow path of this device body, and a valve body that opens and closes a discharge hole formed in this coating nozzle.

A coating process with the adhesive by use of such a robot includes bringing the coating nozzle close to a vicinity of a surface of a workpiece with the robot arm, and then moving the coating nozzle along the surface of the workpiece, while discharging the adhesive through the discharge hole of the coating nozzle. Thus, the surface of the workpiece is coated with the adhesive.

Patent Document 1: Japanese Unexamined Patent Application, Publication No. 2008-290029

### DISCLOSURE OF THE INVENTION

### Problems to be Solved by the Invention

Additionally, for a purpose of accurately coating a defined area of a workpiece with a high-viscosity fluid material such as an adhesive, it is necessary to sufficiently bring a coating nozzle close to a surface of the workpiece with a robot arm. However, if the coating nozzle comes close to the workpiece, the coating nozzle might unintentionally come in contact with the workpiece during teaching to the robot arm or in an actual coating process. If the coating nozzle comes in contact with the workpiece, needless to say, there is concern that the workpiece is damaged, and there is also concern that the coating nozzle or the robot arm to which the coating nozzle is fixed is damaged due to a load applied from the workpiece to the coating nozzle. To solve the problem, it can be considered that load capacity of a robot be improved to inhibit the robot arm from being damaged, but in this case, there is concern that the robot increases in size.

An object of the present invention is to provide a coating nozzle capable of decreasing a load to be applied to a coating gun and a coating device including this coating nozzle.

### Means for Solving the Problems

(1) A coating nozzle (e.g., an after-mentioned coating nozzle 5) according to the present invention comprises a holder part (e.g., an after-mentioned holder part 6) attachable to a distal-end part of a coating gun (e.g., an after-mentioned coating gun 2), and a nozzle body (e.g., an after-mentioned nozzle body 7) housed in the holder part, and including a discharge opening (e.g., an after-mentioned discharge opening 73) through which a fluid material is discharged, and a valve seat part (e.g., an after-mentioned valve seat part 72) in which a valve member (e.g., an after-mentioned needle valve 42) that opens and closes the discharge opening is seated, the nozzle body comprising a nozzle body distal-end part (e.g., an after-mentioned nozzle body distal-end part 77) in which the discharge opening is formed and which protrudes from a distal-end face of the holder part, the nozzle body being supported by the holder part to slide with respect to the holder part, when a load is applied to the nozzle body distal-end part from a side of the discharge opening to a side of the valve seat part.

(2) In this case, it is preferable that the nozzle body distal-end part is formed with a nozzle tapered surface (e.g., an after-mentioned nozzle tapered surface 78) that increases in diameter from the discharge opening side toward the valve seat part side.

(3) In this case, it is preferable that a nozzle taper angle that is an angle of the nozzle tapered surface to a plane orthogonal to an axis of the nozzle body is 45 degrees or less.

(4) In this case, it is preferable that the distal-end face of the holder part is formed with a holder tapered surface (e.g., an after-mentioned second holder tapered surface 68) that increases in diameter from the discharge opening side toward the valve seat part side.

(5) In this case, it is preferable that the holder part is formed by a material having a tensile strength smaller than a tensile strength of the nozzle body.

(6) A coating device according to the present invention comprising: the coating nozzle according to any one of (1) to (5), and an actuator (e.g., an after-mentioned actuator 31) that moves the valve member forward and backward with respect to the valve seat part, the fluid material being an adhesive, a protruding length of the nozzle body from the distal-end face of the holder part being smaller than a stroke length of the valve member.

### Effects of the Invention

(1) A coating nozzle according to the present invention comprises a nozzle body including a discharge opening and a valve seat part, and a holder part supporting this nozzle body. The nozzle body comprises a nozzle body distal-end part protruding from a distal-end face of the holder part. Furthermore, the nozzle body is supported by the holder part to slide with respect to the holder part, when a load is applied to the nozzle body distal-end part from a side of the discharge opening to a side of the valve seat part. Therefore, if the nozzle body distal-end part forming a distal end of the coating nozzle comes in contact with a workpiece and the load is applied from the workpiece to the nozzle body distal-end part from the discharge opening side to the valve seat part side, the nozzle body slides with respect to the holder part, and hence a load applied from the workpiece to the holder part and to a coating gun to which the holder part is attached can be decreased.

(2) In the coating nozzle according to the present invention, the nozzle body distal-end part is formed with a nozzle tapered surface that increases in diameter from the discharge opening side toward the valve seat part side. Consequently, if a load along a radial direction, i.e., a load in a direction orthogonal to an axis of the nozzle body is applied to the nozzle body distal-end part, this load along the radial direction is converted to a load along an axial direction, and the nozzle body can be slid with respect to the holder part as described above. Therefore, also in a case where the load along the radial direction is applied from the workpiece to the nozzle body distal-end part, a load to be applied to the holder part or the coating gun can be decreased.

(3) According to the coating nozzle of the present invention, a nozzle taper angle of the nozzle tapered surface to a plane orthogonal to the axis of the nozzle body is 45 degrees or less, so that the load along the radial direction can be easily converted to the load along the axial direction.

(4) The holder part is required to have both a support function and a buffer function for the nozzle body. The support function is a function of supporting the nozzle body during usual use for coating with a fluid material. Furthermore, the buffer function is a function of inhibiting the load from being applied to the coating gun to which the holder part is attached, in a case where the nozzle body comes in contact with the workpiece. On the other hand, in the coating nozzle according to the present invention, the distal-end face of the holder part is formed as a tapered surface, whereby a thickness of a portion of the holder part, which supports the nozzle body can be adjusted so that the support function is compatible with the buffer function.

(5) According to the coating nozzle of the present invention, as a material of the holder part, a material having a tensile strength smaller than a tensile strength of the nozzle body is used, so that the holder part can be easily deformed while securing durability of the nozzle body, and shock absorption can be secured.

(6) In a coating device including the coating nozzle according to the present invention, if the load is applied to the nozzle body, the nozzle body slides with respect to the holder part, and hence there is concern that an actuator that moves a valve member forward and backward will be damaged via the valve member that comes in contact with the valve seat part of the nozzle body. On the other hand, in the coating device according to the present invention, a protruding length of the nozzle body from the distal-end face of the holder part is smaller than a stroke length of the valve member. Therefore, even in a case where the valve member is seated in the valve seat part when the workpiece comes in contact with the nozzle body distal-end part, the valve member slides within a range of the stroke length, and hence a load to be applied to the actuator, via this valve member can be decreased. Therefore, according to the coating device of the present invention, load capacity of the actuator does not have to be increased uselessly, and hence the coating device can be decreased in size.

### BRIEF DESCRIPTION OF THE DRAWINGS

FIG. 1 is a view showing a configuration of a coating system comprising a coating device according to an embodiment of the present invention;

FIG. 2 is a cross-sectional view of a coating nozzle; and

FIG. 3 is a view showing a configuration of a distal-end part of the coating nozzle.

### PREFERRED MODE FOR CARRYING OUT THE INVENTION

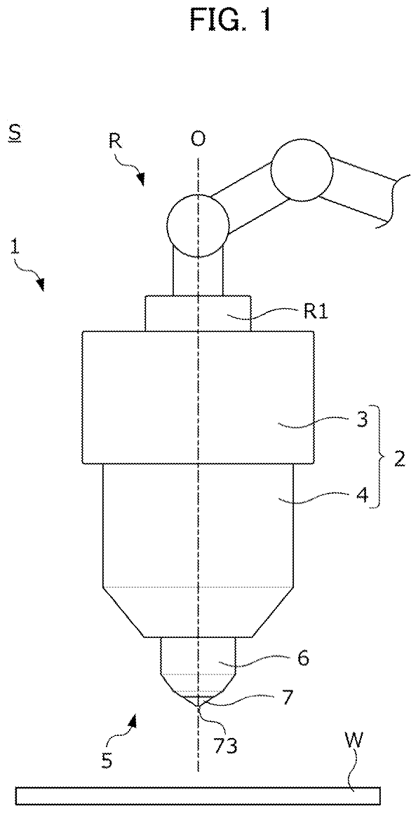

Hereinafter, description will be made as to an embodiment of the present invention with reference to the drawings. FIG. 1 is a view showing a configuration of a coating system S comprising a coating device 1 according to the present embodiment. The coating system S comprises the coating device 1 that discharges an adhesive, and an articulated robot arm R that changes a position and posture of the coating device 1. Note that hereinafter, an example of the coating device 1 that discharges a thermoplastic adhesive being a fluid material will be described, but the present invention is not limited to this example. As the fluid material, in addition to the thermoplastic adhesive, a sealant, a filler or the like may be used.

The coating device 1 comprises a columnar coating gun 2 fixed coaxially with an arm distal-end part R1 of the robot arm R, and a columnar coating nozzle 5 attached to a distal-end part of the coating gun 2. The coating gun 2 supplies the adhesive to the coating nozzle 5, and the coating nozzle 5 discharges the adhesive through a discharge opening 73 formed in a distal end of the nozzle, to coat a surface of a workpiece W with this adhesive.

The coating gun 2 comprises a cylindrical gun base 4 supporting the coating nozzle 5, and a gun body 3 supplying the adhesive to the coating nozzle 5 via the gun base 4.

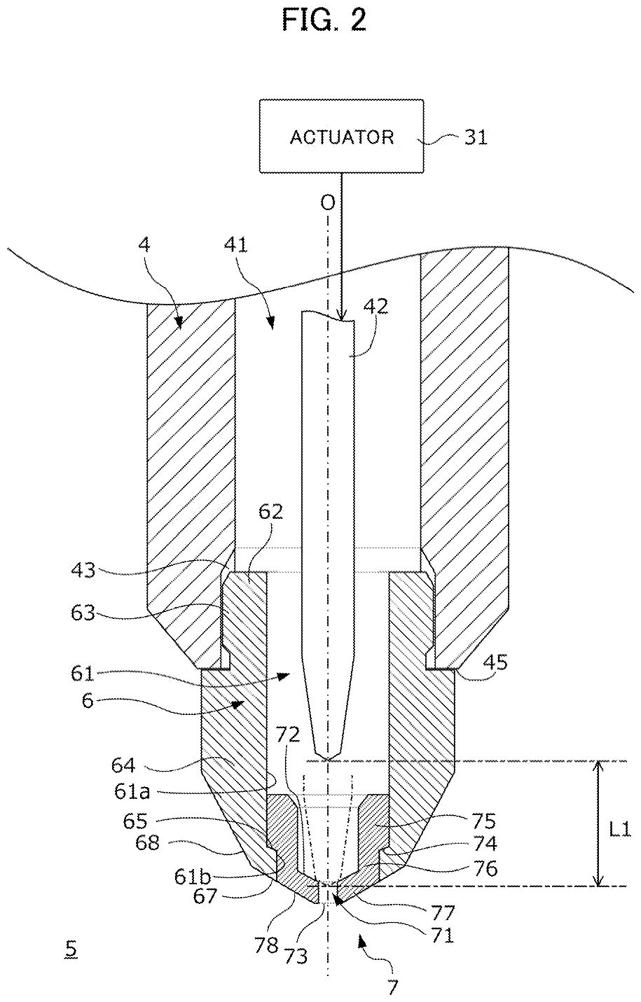

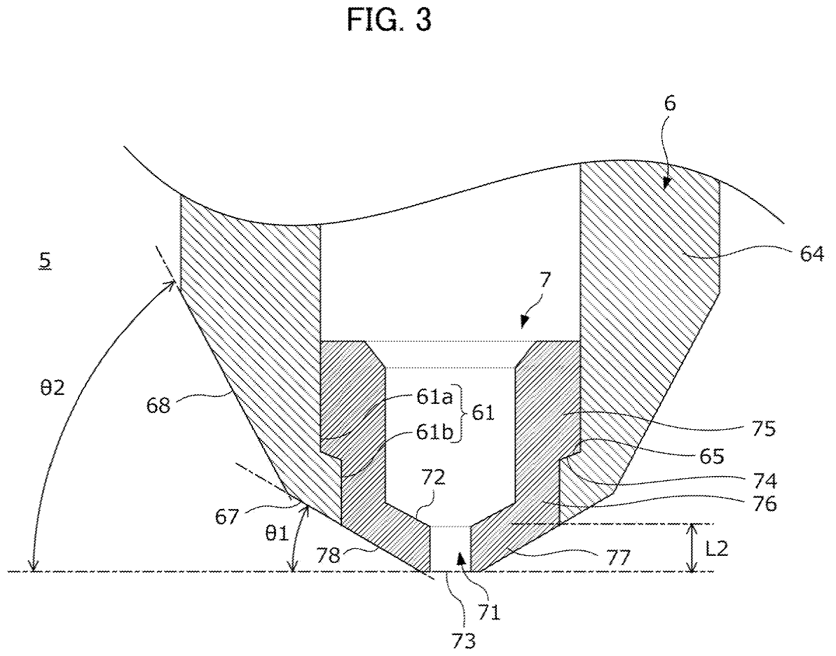

FIG. 2 is a cross-sectional view of the coating nozzle 5, and FIG. 3 is a side view showing a configuration of a distal-end part of the coating nozzle 5. The gun base 4 is cylindrical, in which a flow path 41 extending along a center axis O is formed. Furthermore, in the flow path 41, a needle valve 42 is provided as a rod-like valve member movable forward and backward along the center axis O. On an inner wall surface of the adhesive flow path 41 on a distal-end part side, a spiral internal thread 43 is formed. The coating nozzle 5 is attached to a distal-end part of the gun base 4 by screwing an external thread 63 formed on an after-mentioned holder part 6 into the internal thread 43.

The gun body 3 supplies the adhesive into the flow path 41 of the gun base 4 with a predetermined pressure. Furthermore, the gun body 3 is provided with an actuator 31 that moves the needle valve 42 forward and backward along the center axis O. The actuator 31 moves the needle valve 42 forward and backward along the center axis O with respect to a valve seat part 72 formed in the coating nozzle 5, so that a distal-end part of the needle valve 42 is seated in or moved away from the valve seat part 72. The needle valve 42 is provided slidably over a stroke length L1 along the center axis O by the gun base 4. The stroke length L1 is, for example, about 5 mm.

The coating nozzle 5 is formed by combining the holder part 6 attached to a distal end of the gun base 4, and the nozzle body 7 housed in the holder part 6.

The holder part 6 is cylindrical, in which a flow path 61 extending along the center axis O is formed. The holder part 6 is divided into a base-end part 62 on a base end side and a distal-end part 64 on a distal-end side along the center axis O. The holder part 6 is supported by the gun base 4 in the base-end part 62. Furthermore, the holder part 6 supports the nozzle body 7 in the distal-end part 64.

The spiral external thread 63 is formed in a circumferential surface of the base-end part 62 of the holder part 6. As shown in FIG. 2, if the external thread 63 is screwed into the internal thread 43 to attach the holder part 6 to the distal end of the gun base 4, the flow path 61 of the holder part 6 and the flow path 41 of the gun base 4 are coaxially connected, and furthermore, a part of the distal-end part 64 of the holder part 6 is exposed from a distal-end face 45 of the gun base 4.

The distal-end part 64 of the holder part 6 is slightly thicker than the base-end part 62. A stepped stopper 65 is formed on an inner wall of the distal-end part 64. The flow path 61 is divided into a base-end side large diameter flow path 61a and a distal-end side small diameter flow path 61b via the stopper 65 as a boundary. As shown in FIG. 2 and FIG. 3, an inner diameter of the small diameter flow path 61b is smaller than an inner diameter of the large diameter flow path 61a.

As shown in FIG. 2, a distal-end face of the holder part 6 has a tapered shape that increases in diameter from the distal-end side toward the base-end side along the center axis O. Consequently, a thickness of the holder part 6 decreases from the base-end side toward the distal-end side along the center axis O. More specifically, the distal-end face of the holder part 6 is constituted of a distal-end side first holder tapered surface 67, and a base-end side second holder tapered surface 68.

The first holder tapered surface 67 is flush with an after-mentioned nozzle tapered surface 78, and a taper angle θ1 of the surface (more specifically, an angle of the tapered surface to a plane orthogonal to the center axis O) is also equal to a taper angle of the nozzle tapered surface 78.

A taper angle θ2 of the second holder tapered surface 68 is larger than the taper angle θ1 of the first holder tapered surface 67. More specifically, the taper angle of the second holder tapered surface 68 is, for example, about 60 degrees.

The holder part 6 described above is formed by a material having a tensile strength smaller than a tensile strength of the nozzle body 7. More specifically, the holder part 6 is formed by, for example, aluminum alloy.

The nozzle body 7 is cylindrical, and includes the discharge opening 73 formed as an opening through which the adhesive is discharged, on the distal-end side, and the valve seat part 72 in which the needle valve 42 is seated is formed on the base-end side of the discharge opening 73. Furthermore, in the nozzle body 7, a flow path 71 extending along the center axis O from the valve seat part 72 to the discharge opening 73 is formed.

A stepped shoulder part 74 is formed on an outer wall of the nozzle body 7. Furthermore, the nozzle body 7 is divided into a base-end side large diameter part 75 and a small diameter part 76 having an outer diameter smaller than an outer diameter of the large diameter part 75, via the shoulder part 74 as a boundary along the center axis O. The outer diameter of the large diameter part 75 is almost equal to the inner diameter of the large diameter flow path 61a of the holder part 6, and the outer diameter of the small diameter part 76 is almost equal to the inner diameter of the small diameter flow path 61b of the holder part 6. Therefore, if the nozzle body 7 is inserted into the flow path 61 of the holder part 6 from the base-end side to the distal-end side along the center axis O, the shoulder part 74 abuts on the stopper 65. Consequently, the flow path 71 of the nozzle body 7 and the flow path 61 of the holder part 6 are coaxially connected around the center axis O. Thus, the nozzle body 7 is attached to the holder part 6, and then sliding of the nozzle body 7 from a valve seat part 72 side to a discharge opening 73 side is regulated by the stopper 65. On the other hand, sliding of the nozzle body 7 from the discharge opening 73 side to the valve seat part 72 side is not regulated by the stopper 65.

Furthermore, as shown in FIG. 2, if the nozzle body 7 is pushed along the flow path 61 until the shoulder part 74 abuts on the stopper 65, a distal-end part of the nozzle body 7 including the discharge opening 73 protrudes from the first holder tapered surface 67 of the holder part 6. Hereinafter, a part of the nozzle body 7 which protrudes from the first holder tapered surface 67 to the distal-end side when the nozzle body 7 is attached to the holder part 6 will be referred to as a nozzle body distal-end part 77.

A distal-end face of the nozzle body distal-end part 77 forms a nozzle tapered surface 78 that increases in diameter from the discharge opening 73 side toward the valve seat part 72 side along the center axis O. A taper angle of the nozzle tapered surface 78 is 45 degrees or less, and is, for example, about 30 degrees.

A protruding length L2 of the nozzle body distal-end part 77 from the first holder tapered surface 67 of the holder part 6 is smaller than the stroke length L1 of the needle valve 42. More specifically, the protruding length L2 of the nozzle body distal-end part 77 is, for example, about 1 mm.

The nozzle body 7 described above is formed by, for example, a material having a tensile strength larger than a tensile strength of the holder part 6. More specifically, the nozzle body 7 is formed by, for example, cemented carbide (specifically, for example, tungsten carbide). Note that the material of the nozzle body 7 is not limited to such a material as described above, as long as the material has a tensile strength larger than a tensile strength of the material of the holder part 6, and a steel material or the like may be used.

Next, description will be made as to a procedure of attaching the coating nozzle 5 described above to the gun base 4. First, the nozzle body 7 is attached to the holder part 6, to assemble the coating nozzle 5. More specifically, first, outer peripheral surfaces of the large diameter part 75 and small diameter part 76 of the nozzle body 7 are coated with the adhesive. Next, the nozzle body 7 coated with the adhesive is inserted into the flow path 61 of the holder part 6 along the center axis O from the base-end side to the distal-end side, so that the shoulder part 74 of the nozzle body 7 abuts on the stopper 65 of the holder part 6. Consequently, the nozzle body 7 is fitted in and supported by the holder part 6. Note that in the present embodiment, a case of fixing the nozzle body 7 and the holder part 6 with the adhesive is described, but the adhesive does not necessarily have to be used. The nozzle body 7 may be attached to the holder part 6 by press-fit (more specifically, light press-fit, shrink-fit or the like).

As described above, movement of the nozzle body 7 from the discharge opening 73 side to the valve seat part 72 side is not regulated by the stopper 65. Therefore, if the nozzle body 7 is supported by the holder part 7 by use of support means such as fit-support, the adhesive, the press-fit or the like as described above and a load is thus applied to the nozzle body distal-end part 77 from the discharge opening 73 side to the valve seat part 72 side, the nozzle body 7 slides with respect to the holder part 6 along the center axis O from the discharge opening 73 side to the valve seat part 72 side.

Next, the coating nozzle 5 assembled as described above is attached to the gun base 4 to which the needle valve 42 is set in advance. More specifically, the external thread 63 of the holder part 6 is screwed into the internal thread 43 of the gun base 4 along the center axis O. Thus, the coating nozzle 5 is attached to the gun base 4.

According to the coating device 1 assembled as described above, the coating with the adhesive is performed by a procedure described below. First, the robot arm R is controlled, to bring the discharge opening 73 of the coating nozzle 5 close to the surface of the workpiece W. Thereafter, the needle valve 42 is moved away from the valve seat part 72, while supplying the adhesive from the gun body 3 to the coating nozzle 5 with a predetermined pressure by an unshown adhesive supply device, and the adhesive is thus discharged through the discharge opening 73. Thereafter, while discharging the adhesive through the discharge opening 73, the robot arm R is controlled, to move the discharge opening 73 in a predetermined coating region along the surface of the workpiece W, and then the needle valve 42 is seated in the valve seat part 12. Consequently, the coating region of the surface of the workpiece W is coated with the adhesive.

The present embodiment is effective as follows. (1) The coating nozzle 5 comprises the nozzle body 7 including the discharge opening 73 and the valve seat part 72, and the holder part 6 supporting the nozzle body 7. The nozzle body 7 comprises the nozzle body distal-end part 77 protruding from the first holder tapered surface 67 that is the distal-end face of the holder part 6. Furthermore, the nozzle body 7 is supported by the holder part 6 to slide with respect to the holder part 6, when the load is applied to the nozzle body distal-end part 77 from the discharge opening 73 side to the valve seat part 72 side. Therefore, if the nozzle body distal-end part 77 forming the distal end of the coating nozzle 5 comes in contact with the workpiece W and the load is applied from the workpiece W to the nozzle body distal-end part 77 from the discharge opening 73 side to the valve seat part 72 side, the nozzle body 7 slides with respect to the holder part 6, and hence a load applied from the workpiece W to the holder part 6 and to the coating gun 3 to which the holder part 6 is attached can be decreased.

(2) The nozzle body distal-end part 77 is formed with the nozzle tapered surface 78 that increases in diameter from the discharge opening 73 side toward the valve seat part 72 side. Consequently, in a case where a load along a radial direction orthogonal to the center axis O is applied to the nozzle body distal-end part 77, this load along the radial direction is converted to a load along a center axis O direction, and the nozzle body 7 can be slid with respect to the holder part 6 as described above. Therefore, also in a case where the load along the radial direction is applied from the workpiece W to the nozzle body distal-end part 77, a load to be applied to the holder part 6 or the coating gun 2 can be decreased.

(3) According to the coating nozzle 5, a nozzle taper angle of the nozzle tapered surface 78 to a plane orthogonal to the center axis O of the nozzle body 7 is 45 degrees or less, so that the load along the radial direction can be easily converted to the load along the center axis O direction.

(4) The holder part 6 is required to have both a support function and a buffer function for the nozzle body 7. On the other hand, in the coating nozzle 5, the first holder tapered surface 67 and the second holder tapered surface 67 that form the distal-end face of the holder part 6 are formed as the tapered surfaces, whereby a thickness of the distal-end part 64 of the holder part 6 which supports the nozzle body 7 can be adjusted so that the support function is compatible with the buffer function.

(5) According to the coating nozzle 5, as the material of the holder part 6, the material having the tensile strength smaller than the tensile strength of the nozzle body 7 is used, so that the holder part 6 can be easily deformed while securing durability of the nozzle body 7, and shock absorption can be secured.

(6) In the coating device 1 including the coating nozzle 5, if the load is applied to the nozzle body 7, the nozzle body 7 slides with respect to the holder part 6, and hence there is concern that the actuator 31 that moves the needle valve 42 forward and backward will be damaged via the needle valve 42 that comes in contact with the valve seat part 72 of the nozzle body 7. On the other hand, in the coating device 1, the protruding length L2 of the nozzle body 7 from the first holder tapered surface 67 of the holder part 6 is smaller than the stroke length L1 of the needle valve 42. Therefore, even in a case where the needle valve 42 is seated in the valve seat part 72 when the workpiece W comes in contact with the nozzle body distal-end part 77, the needle valve 42 slides within a range of the stroke length L1, and hence a load to be applied to the actuator 31 via the needle valve 42 can be decreased. Therefore, according to the coating device 1, load capacity of the actuator 31 does not have to be increased uselessly, and hence the coating device 1 can be decreased in size.

As above, one embodiment of the present invention has been described, but the present invention is not limited to this embodiment. Configurations of details may be appropriately modified within a gist of the present invention.

### EXPLANATION OF REFERENCE NUMERALS

S coating system

R robot arm

1 coating device

O center axis

2 coating gun

31 actuator

42 needle valve (a valve member)

5 coating nozzle

6 holder part

67 first holder tapered surface

68 second holder tapered surface (a holder tapered surface)

7 nozzle body

72 valve seat part

73 discharge opening

77 nozzle body distal-end part 77

78 nozzle tapered surface

1. A coating nozzle comprising:
a holder part attachable to a distal-end part of a coating gun; and
a nozzle body housed in the holder part, and including a discharge opening through which a fluid material is discharged, and a valve seat part in which a valve member that opens and closes the discharge opening is seated,
the nozzle body comprising a nozzle body distal-end part in which the discharge opening is formed and which protrudes from a distal-end face of the holder part,
the nozzle body being supported by the holder part to slide with respect to the holder part, when a load is applied to the nozzle body distal-end part from a side of the discharge opening to a side of the valve seat part.

2. The coating nozzle according to claim 1, wherein the nozzle body distal-end part is formed with a nozzle tapered surface that increases in diameter from the discharge opening side toward the valve seat part side.

3. The coating nozzle according to claim 2, wherein a nozzle taper angle that is an angle of the nozzle tapered surface to a plane orthogonal to an axis of the nozzle body is 45 degrees or less.

4. The coating nozzle according to claim 1, wherein the distal-end face of the holder part is formed with a holder tapered surface that increases in diameter from the discharge opening side toward the valve seat part side.

5. The coaling nozzle according to claim 4, wherein the holder part is formed by a material having a tensile strength smaller than a tensile strength of the nozzle body.

6. A coating device comprising:
the coating nozzle according to claim 1; and
an actuator that moves the valve member forward and backward with respect to the valve seat part, the fluid material being an adhesive,
a protruding length of the nozzle body from the distal-end face of the holder part being smaller than a stroke length of the valve member.

7. The coating nozzle according to claim 2, wherein the distal-end face of the holder part is formed with a holder tapered surface that increases in diameter from the discharge opening side toward the valve seat part side.

8. The coating nozzle according to claim 7, wherein the holder part is formed by a material having a tensile strength smaller than a tensile strength of the nozzle body.

9. The coating nozzle according to claim 3, wherein the distal-end face of the holder part is formed with a holder tapered surface that increases in diameter from the discharge opening side toward the valve seat part side.

10. The coating nozzle according to claim 9, wherein the holder part is formed by a material having a tensile strength smaller than a tensile strength of the nozzle body.

11. A coating device comprising:
the coating nozzle according to claim 2; and
an actuator that moves the valve member forward and backward with respect to the valve seat part, the fluid material being an adhesive,
a protruding length of the nozzle body from the distal-end face of the holder part being smaller than a stroke length of the valve member.

12. A coating device comprising:
the coating nozzle according to claim 3; and
an actuator that moves the valve member forward and backward with respect to the valve seat part, the fluid material being an adhesive,
a protruding length of the nozzle body from the distal-end face of the holder part being smaller than a stroke length of the valve member.

13. A coating device comprising:
the coating nozzle according to claim 4: and
an actuator that moves the valve member forward and backward with respect to the valve seat part, the fluid material being an adhesive,
a protruding length of the nozzle body from the distal-end face of the holder part being smaller than a stroke length of the valve member.

14. A coating device comprising:
the coating nozzle according to claim 5; and
an actuator that moves the valve member forward and backward with respect to the valve seat part, the fluid material being an adhesive,
a protruding length of the nozzle body from the distal-end face of the holder part being smaller than a stroke length of the valve member.

15. A coating de vice comprising:
the coating nozzle according to claim 7; and
an actuator that moves the valve member forward and backward with respect to the valve seat part, the fluid material being an adhesive,
a protruding length of the nozzle body from the distal-end face of the holder part being smaller than a stroke length of the valve member.

16. A coating device comprising:
the coating nozzle according to claim 8; and
an actuator that moves the valve member forward and backward with respect to the valve seat part, the fluid material being an adhesive,
a protruding length of the nozzle body from the distal-end face of the holder part being smaller than a stroke length of the valve member.

17. A coating device comprising:
the coating nozzle according to claim 9; and
an actuator that moves the valve member forward and backward with respect to the valve seat part, the fluid material being an adhesive,
a protruding length of the nozzle body from the distal-end face of the holder part being smaller than a stroke length of the valve member.

18. A coating device comprising:
the coating nozzle according to claim 10; and
an actuator that moves the valve member forward and backward with respect to the valve seat part, the fluid material being an adhesive,
a protruding length of the nozzle body from the distal-end face of the holder part being smaller than a stroke length of the valve member.
